(19) United States
(12) Patent Application Publication
(10) Pub. No.: US 2002/0027118 A1
(43) Pub. Date: Mar. 7, 2002

(54) Vehicle crane

(76) Inventor: Hans-Dieter Willim, Ulm (DE)

Correspondence Address: JACOBSON HOLMAN PLLC, 400 SEVENTH STREET N.W., SUITE 600, WASHINGTON, DC, 20004, US

(21) Appl. No.: 09/928,238

(22) Filed: Aug. 13, 2001

(30) Foreign Application Priority Data
Aug. 11, 2000 (DE) 200 13 893.6

(51) Int. Cl. B66C 23/72

(52) U.S. Cl. 212/302

(57) ABSTRACT

A vehicle crane with four supports, which are hinged to the vehicle frame and which can be swung out, and with a rotating deck, which is mounted on said vehicle frame, is provided with swivel bearings for a main boom and a derrick counterboom. In order to transport the vehicle crane in a simple manner from one work site to another and to erect it easily at the respective work site so that it is ready to operate, a counterboom foot piece, which can be set down on the vehicle during transport and to which a counterboom headpiece can be coupled, is connected to the rotating deck.

The invention relates to a vehicle crane with four supports, which are hinged to the vehicle frame and which can be swung out, and with a rotating deck, which is mounted on said vehicle frame and which is provided with swivel bearings for a main boom and a derrick counterboom.

Such vehicle cranes are usually large cranes for lifting and swinging large loads so that the cranes themselves have a high intrinsic weight, which prevents them from being transported in the completed state with a vehicle, even if said vehicle exhibits eight to ten axles. To erect such large derrick cranes for operation on site, it is, therefore, necessary to transport the main boom, the derrick counterboom or parts of these booms and the ballast with several vehicles to the work site. To assemble the separate parts of the crane that are brought in by vehicles, it is then necessary to use the crane's own erection crane, a feature that requires additional equipment, in addition to the necessary erection work.

Therefore, the object of the invention is to provide a vehicle crane of the class described in the introductory part for lifting and swinging the heaviest loads. At the same time it ought to be simple to transport to the work site and fast to assemble and disassemble at the respective work site.

The invention solves this problem associated with a vehicle crane of the aforementioned class in that a counterboom foot piece, which can be set down on the vehicle during transport and to which a counterboom headpiece can be coupled, is connected to the rotating deck.

The inventive vehicle crane can be designed in such a manner that the preferably eight to ten axle vehicle is loaded up to the limit of the admissible dimensions and weights during road transport. The counterboom foot piece, which the vehicle crane brings along in the assembled state, exhibits only such a weight that the crane vehicle or its axles are loaded up to the admissible limits.

A further development of the invention provides that an erection crane with luffable boom is disposed in the area of the end of the counterboom member, which is provided with the coupling or connecting units. With this erection crane the separately transported counterboom headpiece can be lifted from a transport vehicle and aligned in such a manner with respect to the counterboom foot piece that the coupling or connecting units of both boom members can be aligned in such a manner relative to each other that they can be easily and quickly connected, for example, by bolting them together.

To enable a simple connection of both counterboom members, another embodiment of the invention provides that the separately transportable counterboom headpiece exhibits its center of mass, which is shifted in the direction of the end with the coupling or the connecting units, so that it can be moved with the short length of the boom of the erection crane for the purpose of connecting with the counterboom foot piece.

One embodiment of the invention provides that the counterboom can be swung by means of its luffing cylinder about an angle, which is larger than 90 degrees, in the direction of the hinging point of the main boom of the rotating deck. This design makes it possible to use the counterboom itself as the erection crane for assembling the separately transported main boom. To be able to remove, lift and swing the main boom from its transport vehicle, the counterboom is provided with an adjusting block, which is equipped with a hook.

Expediently the counterboom headpiece is provided with two adjusting blocks, of which the one serves to guy the counter and main booms in relation to each other and the other serves to accommodate the ballast.

To transport the counterboom headpiece with reeved adjusting blocks, the adjusting blocks can be attached preferably in the holding units, provided on both sides of the counterboom headpiece, by means of their cable reeving.

Each of the two adjusting blocks can be adjusted by means of a double winch.

The main boom can be a telescope or a lattice boom.

The adjusting block, serving the purpose of erecting the main boom, can be connected to the headpiece of the main boom or to a bar or cable, connected to the same, for the purpose of guying the headpieces of the main boom and counterboom with respect to each other.

A further development of the invention provides that the ballast can be received with the other adjusting block and moved inside the tilt edge of the support rectangle. This design increases the stability of the crane and, therefore, it is not necessary to set down the counterballast when the main boom does not carry an adequately large counterbalancing load.

The swivelable support arms, mounted on the vehicle frame, can be swung in pairs parallel to each other so as to hinge to the vehicle and additionally can also be disassembled. The support arms for the large crane exhibit a significant weight, so that it may be necessary to disassemble at least temporarily the support arms before travelling, for example, over bridges.

Another embodiment of the invention provides that the support frame of the drive unit is connected in such a manner to the rotating deck so as to swivel that for transport it can be swung onto the vehicle or the vehicle frame and deposited on either vehicle or frame. This moveability guarantees that the drive unit is located within the admissible dimensions of the vehicle during transport.

Similarly the crane cab can be connected to the rotating deck by means of a support arm in such a manner that it can be swung onto the vehicle or the vehicle frame during transport.

One embodiment of the invention is described in detail below with the aid of the drawings.

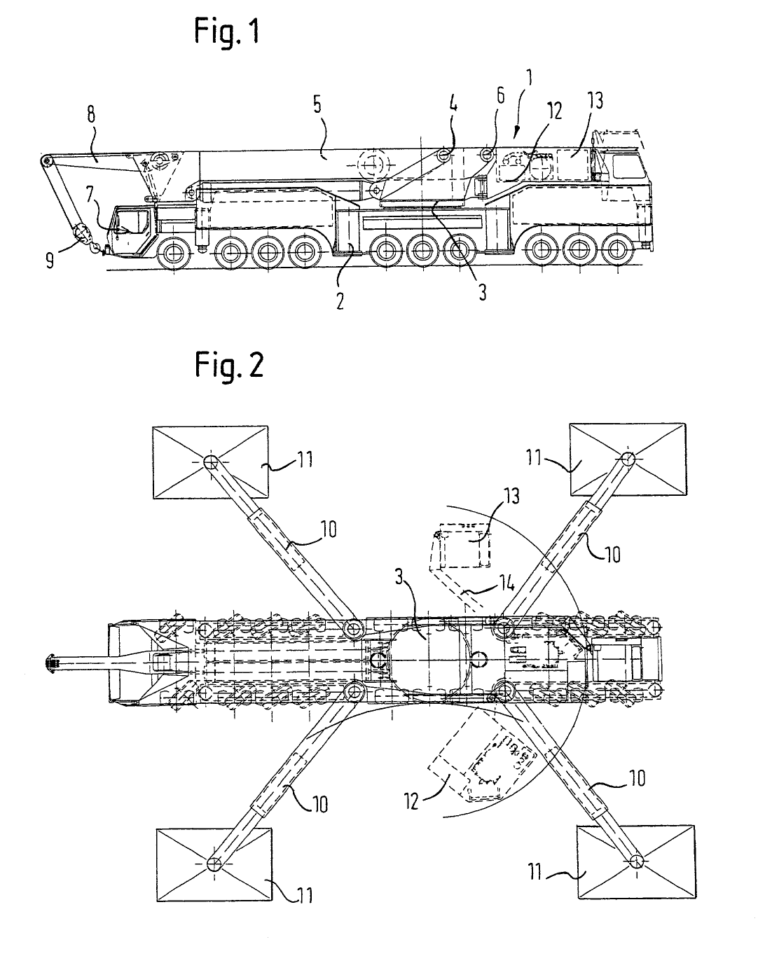

FIG. 1 is a side view of the crane vehicle of the large crane of the invention in its road travelling state.

FIG. 2 is a top view of the crane vehicle, according to FIG. 1, with the support arms swung out and extended and with the foot pieces extended and supported on mats.

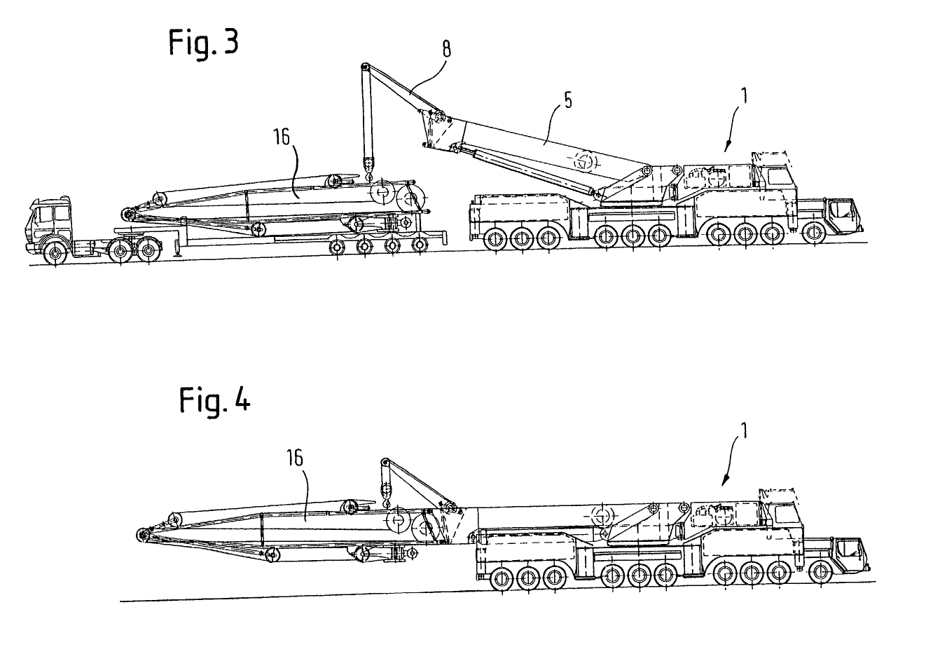

FIG. 3 depicts the crane vehicle, according to FIG. 1, with a special transport vehicle for the counterboom headpiece in a state, in which it is hinged to the erection crane of the counterboom foot piece.

FIG. 4 is a view, corresponding to FIG. 3, where the counterboom headpiece has been moved by the erection crane into the coupling position relative to the counterboom foot piece.

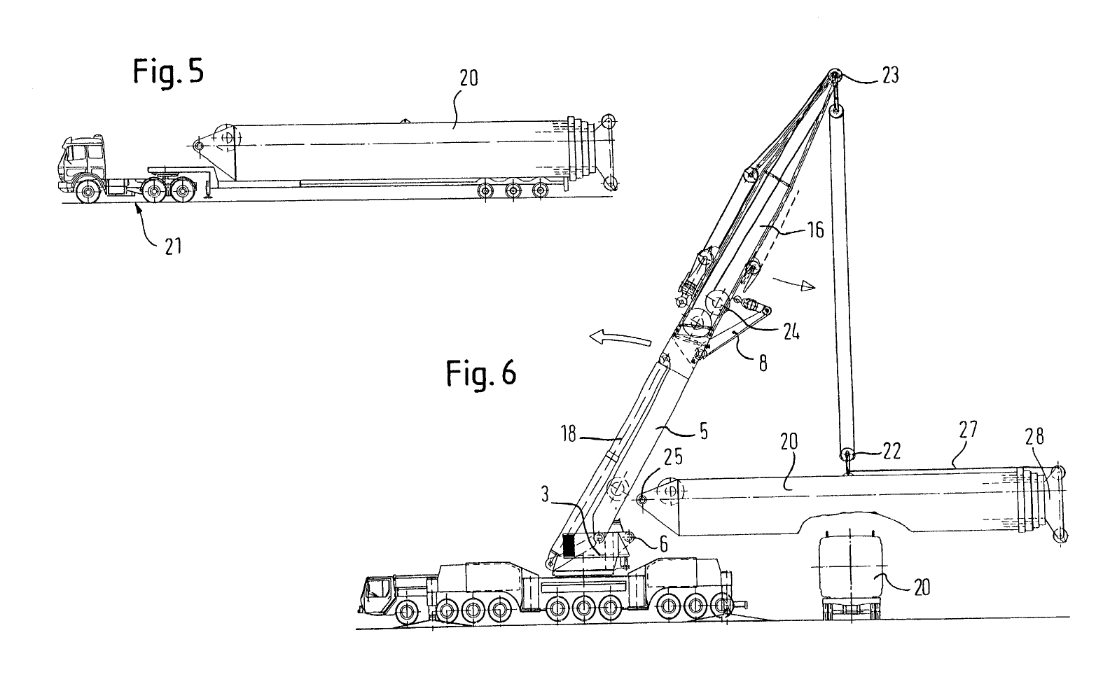

FIG. 5 is a side view of a crane vehicle, transporting the main boom.

FIG. 6 depicts the crane vehicle with completely assembled counterboom while lifting the main boom by means of an adjusting block of the counterboom from a transport vehicle.

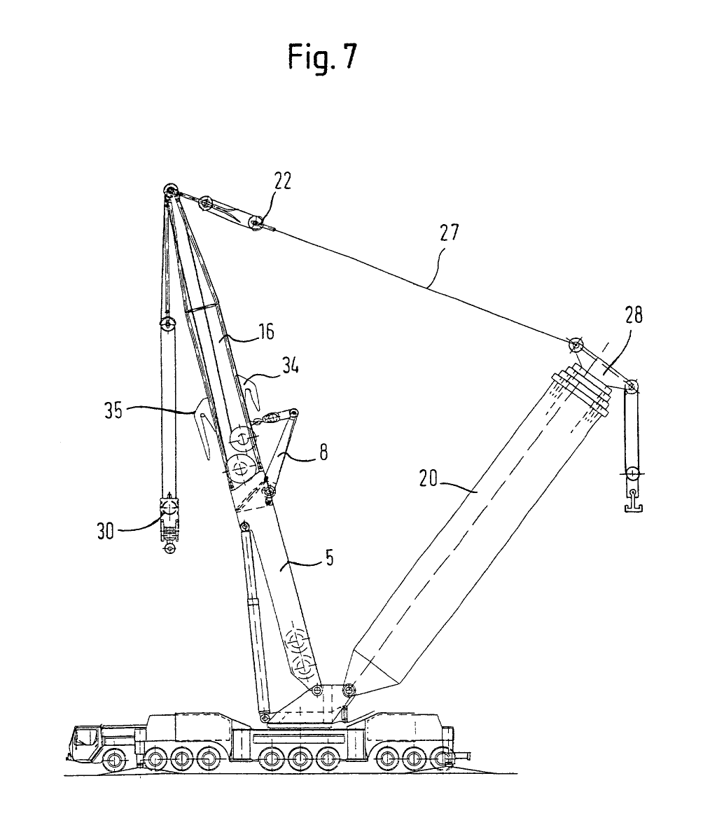

FIG. 7 depicts the crane vehicle with assembled main and counterboom.

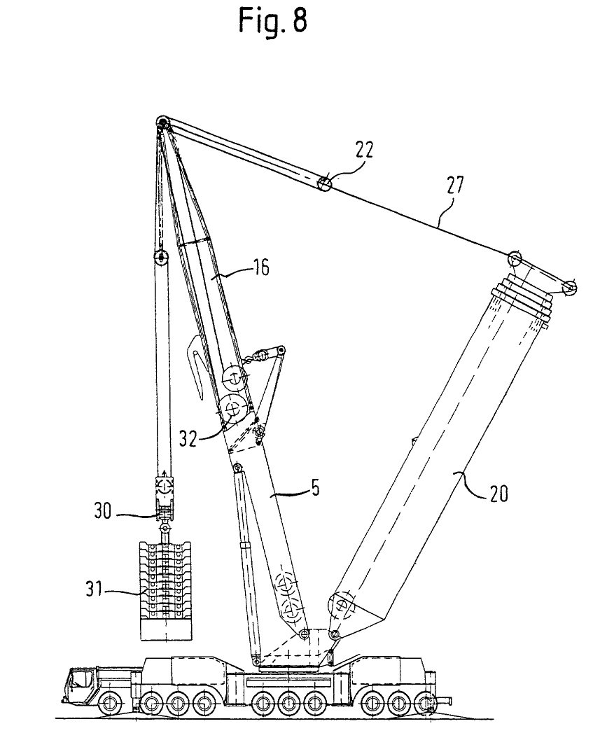

FIG. 8 is a view, corresponding to FIG. 7, where the counterboom has received the ballast.

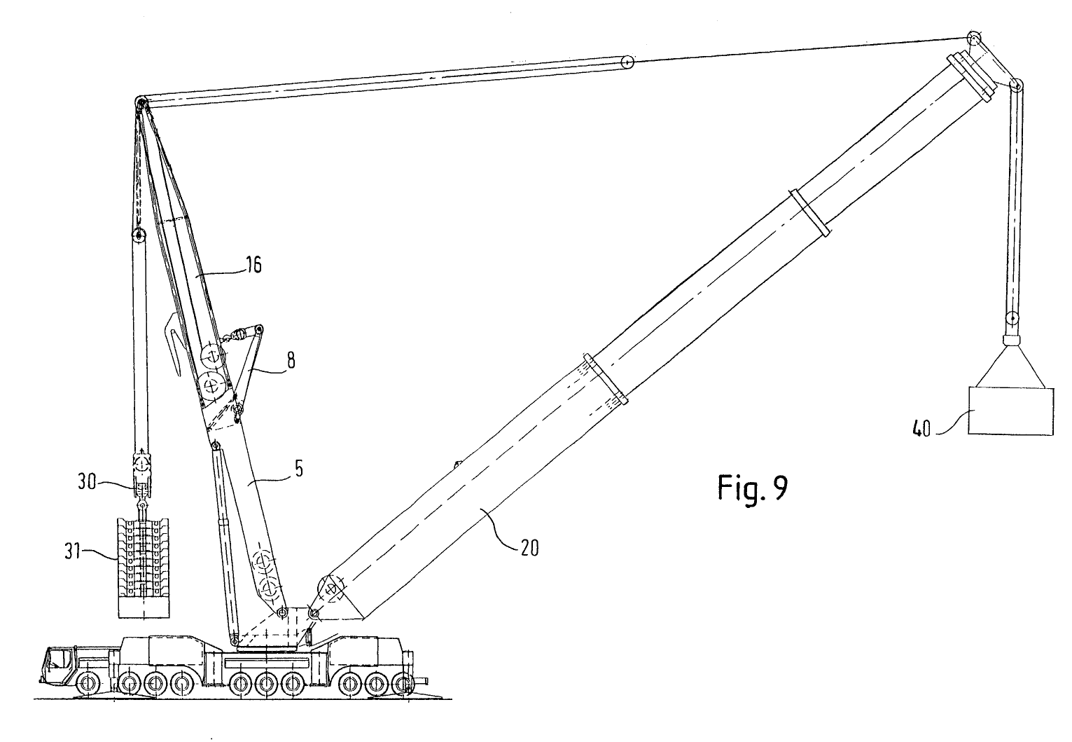

FIG. 9 is a view, corresponding to FIG. 8, with extended main boom and vertical counterboom; and

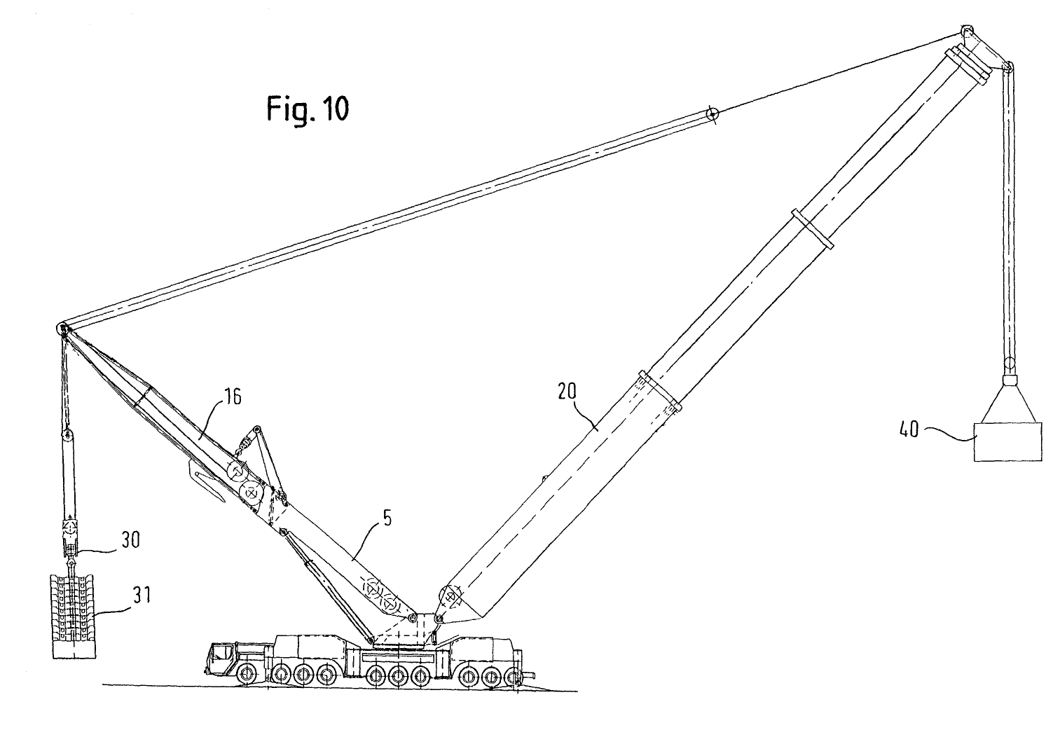

FIG. 10 is a view, corresponding to FIG. 9, where the counterboom has swung out at a large radius the ballast in order to counterbalance a large load, lifted by the main boom.

The crane vehicle 1, visible in FIG. 1, comprises a vehicle frame with ten axles. The rotating deck 3 is mounted in the conventional manner on the lowered center part of the vehicle frame 2 so as to rotate around a vertical axis of rotation and is provided with a rotating drive. The derrick counterboom foot piece 5 is mounted on the rotating deck 3 so as to swivel around the axle bolt 4. To transport this counterboom foot piece, it is swung onto the front piece of the vehicle frame 2 and deposited on the same. The main boom, which can be connected to the rotating deck 3 so as to swivel around the joint bolt 6, is disassembled and is transported to the work site, where the crane is set up ready to operate, by means of a transport vehicle, which is especially evident from FIG. 5. The crane vehicle 1 is provided with a cab 7, beyond which projects the boom 8, which is swivelled into the upper level of the counterboom foot piece 5 and which belongs to an auxiliary or erection crane, which is disposed on the front end of the counterboom headpiece 8. To transport the erection crane so as to be substantially ready to operate, its bottom block 9, provided with a crane hook, can be hooked into an eye, located in the area of the bumper.

Both sides of the rotating deck 3 exhibit the chassis 2 with support arms 10, which can be swung out and extended and whose free ends exhibit bracing plates-bearing support cylinders. The bracing plates rest against special mats 11.

A support frame 12, which receives the drive unit, is hinged to the rotating deck 3 so as to swivel. For the purpose of transport said support frame is set down in the manner, evident from FIG. 1, on the rear part of the chassis in such a manner that it is located within the admissible vehicle dimensions.

Similarly the crane cab 13 is attached to a swivel arm 14 so that for the purpose of transport it can be set down on the vehicle frame behind the drive unit.

To assemble the counterboom headpiece 16, it is driven in the manner, evident from FIG. 3, behind or in front of the crane vehicle 1 by a special transport vehicle in such a manner that it can be received and lifted by the boom 8 of the erection crane. The counterboom headpiece 16 is provided in the area of its center of mass, which is located in the direction of its rear end, with an eye, into which the crane hook of the erection crane can hook. Then the erection crane 8 swings and aligns the counterboom headpiece in such a manner relative to the counterboom foot piece 5 that both parts are in alignment; and the coupling units, which connect the two parts and which comprise preferably the conventional bolt connections, can be closed.

When the derrick counterboom 5, 16 has been erected, it can be swung, as evident from FIG. 6, by means of its luffing cylinder 18, out of its flat position on the chassis of the crane vehicle at an angle, which is greater than 90 degrees, in the direction of the hinging point 6 of the main boom 20. The main boom 20 is transported in the manner shown in FIG. 5 by its own transport vehicle 21 and can then be lifted from the transport vehicle by means of a bottom block 22, which is provided with a crane hook and whose cables run over an upper deflecting roller 23 of the counterboom. To operate the bottom and adjusting block 22, the counterboom headpiece 16 is provided with a winch 24. The main boom 20 with its bearing 25 is driven into the bearing 6 of the rotating deck 3 by means of the lifting unit, provided with the adjusting block 22, so that the articulated connection between the main boom and the rotating deck can be produced by driving in the bolts. After the crane hook of the adjusting block 22 has been disengaged from the main boom, it engages with an eye or a connecting unit of the linkage 27, which is connected to its other end so as to articulate with the head 28 of the main boom 20, which comprises a telescope boom in the illustrated embodiment.

As evident from FIG. 7, the main boom 20 and the counterboom 5, 16 are guyed relative to each other by means of the adjusting block 22 and the linkage 27.

The counterboom 5, 16 is provided with a second adjusting block 30, which serves to receive the ballast 31. To adjust the adjusting block 30, the counterboom headpiece is provided with a second winch 32.

To prevent having to reeve out the reeving of the adjusting blocks 22, 30 during transport, the counterboom headpiece is provided with hooks 34, 35, which can be driven into the adjusting blocks 22, 30 and in which, when completely reeved, they are fixed in position during transport.

FIG. 8 shows the crane in a position, in which the ballast 31 is located inside the tilt edges of the support rectangle so that the necessary stability is guaranteed without the need for the main boom to carry a counterbalancing main load.

To receive the ballast 1, it is set down on the side between the support arms inside the support rectangle so that it can be received by the adjusting block 30 of the counterboom 5, 16.

FIG. 9 shows the crane in a position, in which the telescope boom 20 is partially extended.

FIG. 10 shows the crane in a position, in which the main boom 20 can receive a large load 40 when the counterboom exhibits a large working angle.

The crane of the invention is erected in such a manner that first the frame, which is set on the chassis, is swung out to the side with the drive unit. Then the crane cab is also lifted from the chassis and swung to the side, as evident from FIG. 2.

Due to this swing out operation, the bolting-on point 6 for the main boom is free. The derrick boom foot piece is then lifted with the two hydraulic cylinders, allocated to said foot piece. Then the superstructure can be swung relative to the undercarriage. With the auxiliary erection boom, the bracing mat can be lifted from a low loader and set down under the supports of the support arms.

The erection boom on the derrick boom foot piece is lifted hydraulically and, as evident from FIG. 3, extended. The erection block, located on said foot piece, is set down so far with the built-in erection winch that the counterboom headpiece can be lifted in its center of mass. The winches and the adjusting blocks are arranged in such a manner that the center of mass of the derrick boom headpiece is located near the bolting points relative to the counterboom foot piece so that a short erection length is adequate to lift the counterboom headpiece. Lifting the counterboom headpiece in the center of mass makes it possible to assemble the counterboom headpiece in any arbitrary angular position of the derrick boom headpiece and the derrick boom foot piece. By luffing up and down the counterboom foot piece, the spacing between the counterboom headpiece and the foot piece can be varied. In this manner it is thus possible to make a bolt connection between the boom headpiece and the boom foot piece. The bolt connection between the two parts is done hydraulically. The hydraulic supply lines to the winches are also coupled automatically.

To receive the main boom, the entire derrick counterboom is swung to the front about an angle, which is greater than 90 degrees, until the tip of the derrick counterboom is located above the main boom to be lifted. Then the adjusting block is lowered and bolted together with the main boom. Thus, by swinging the derrick counterboom, the main boom can be swung in such a manner that it can be bolted to the rotating deck. The adjusting block is connected to the main boom head, and the derrick boom is swung back into its operating position. Now the main boom can be lifted between the derrick boom head and the main boom head by means of the adjusting block.

After reeving the hoisting cable, the ballast can be lifted from the low loaders with the main boom and stacked between the support arms. Below the counterboom headpiece there is the ballast adjusting block, with which the entire ballast can be lifted. Since the ballast is located inside the support base, the stability is guaranteed. Upon receiving the load, the center of mass of the entire ballast is inside or only slightly outside the support base so that without the load at the main boom the stability in the rear is guaranteed.

By receiving the load, the stationary moment of the crane is decreased. When lowering the derrick counterboom, the rearward radius of the ballast is increased and thus also the stationary moment. The load is set down in the reverse manner by swinging the derrick counterboom to the front and; and thus the center of mass of the ballast is shifted into the support base. One advantage of the operating mode, enabled by the crane of the invention, lies in the fact that the entire ballast can be swung into the support base so that it is not necessary to alternate the ballast, a feature that was common to date with suspended ballast operation. Furthermore, as the load moment decreases, there is no need for a ballast car to receive the resulting decreasing counterweight.

The derrick ballast is not guided. The derrick counterboom is dimensioned in such a manner especially in the transverse direction that all of the generated acceleration and transverse forces can be absorbed.

The additional adjusting block between the derrick boom headpiece and the ballast makes it possible to tilt the derrick counterboom quite far to the rear and thus to achieve a very large rearward radius. Thus, the transport weight can be decreased. Moreover, the ballast can be lifted so far by means of the adjusting block that it is possible to swing over the impediments in the swing area of the ballast.

1. Vehicle crane
with four supports, which are hinged to the vehicle frame and which can be swung out, and
with a rotating deck, which is mounted on said vehicle frame and which is provided with swivel bearings for a main boom and a derrick counterboom,
characterized in
that a counterboom foot piece, which can be set down on the vehicle during transport and to which a counterboom headpiece can be coupled, is connected to the rotating deck.

2. Vehicle crane, as claimed in claim 1, characterized in that an erection crane with luffable boom is disposed in the area of the end of the counterboom foot piece, which is provided with the coupling or connecting units.

3. Vehicle crane, as claimed in claim 1 or 2, characterized in that the separately transportable counterboom headpiece exhibits its center of mass, which is shifted in the direction of the end with the coupling or the connecting units, so that it can be moved with the short length of the boom of the erection crane for the purpose of connecting with the counterboom foot piece.

4. Vehicle crane, as claimed in any one of the claims 1 to 3, characterized in that the counterboom can be swung by means of its luffing cylinder about an angle, which is larger than 90 degrees, in the direction of the hinging point of the main boom of the rotating deck.

5. Vehicle crane, as claimed in any one of the claims 1 to 4, characterized in that the counterboom headpiece is provided with two adjusting blocks.

6. Vehicle crane, as claimed in any one of the claims 1 to 5, characterized in that the adjusting block can be attached in the holding units, provided on both sides of the counterboom headpiece, by means of its cable reeving.

7. Vehicle crane, as claimed in any one of the claims 1 to 6, characterized in that each of the two adjusting blocks can be adjusted by means of a double winch.

8. Vehicle crane, as claimed in any one of the claims 1 to 7, characterized in that the separately transportable main boom can be moved into its erecting position on the rotating deck by means of an adjusting block of the counterboom, which is swung overhead, said adjusting block being provided with a crane hook.

9. Vehicle crane, as claimed in any one of the claims 1 to 8, characterized in that the main boom is a telescope or a lattice boom.

10. Vehicle crane, as claimed in any one of the claims 1 to 9, characterized in that the adjusting block, serving the purpose of erecting the main boom, can be connected to the headpiece of the main boom or to a bar or cable, connected to the same, for the purpose of guying the headpieces of the main boom and counterboom with respect to each other.

11. Vehicle crane, as claimed in any one of the claims 1 to 10, characterized in that the ballast can be received with the other adjusting block and moved as far as inside the tilt edges of the support rectangle.

12. Vehicle crane, as claimed in any one of the claims 1 to 11, characterized in that the swivelable support arms, mounted on the vehicle, can be set down in pairs parallel to each other on the vehicle and preferably also disassembled.

13. Vehicle crane, as claimed in any one of the claims 1 to 12, characterized in that the support frame of the drive unit is connected in such a manner to the rotating deck so as to swivel that for transport it can be swung onto the vehicle or the vehicle frame.

14. Vehicle crane, as claimed in any one of the claims 1 to 13, characterized in that the crane cab is connected to the rotating deck by means of a support arm in such a manner that it can be swung onto the vehicle or the vehicle frame for transport.
